(19) United States
(12) Patent Application Publication
(10) Pub. No.: US 2021/0140778 A1
(43) Pub. Date: May 13, 2021

(54) Terminal, Server, Multi Mobility Service System Including the Same and Method Thereof

(71) Applicants: Hyundai Motor Company, Seoul (KR); Kia Motors Corporation, Seoul (KR)

(72) Inventor: Dong Uk Kim, Incheon (KR)

(21) Appl. No.: 16/799,214

(22) Filed: Feb. 24, 2020

(30) Foreign Application Priority Data
Nov. 12, 2019 (KR) 10-2019-0144609

(51) Int. Cl. G01C 21/34; G01C 21/36; H04W 4/40

(52) U.S. Cl. CPC G01C 21/3484; H04W 4/40; G01C 21/3605

(57) ABSTRACT

A multi mobility service system according to an embodiment of the present disclosure includes a plurality of terminals for generating user preferences based on vehicle information and user information, and a server for generating traveling path information for passing through a selected gathering place among one or more gathering places derived based on the user preferences. Therefore, the multi mobility service system may provide a service that provides a path for traveling to a destination with optimal cost and time by reflecting preferences of a plurality of users, and automatically pays a cost generated when traveling.

### CROSS-REFERENCE TO RELATED APPLICATIONS

This application claims priority to Korean Patent Application No. 10-2019-0144609, filed in the Korean Intellectual Property Office on Nov. 12, 2019, which application is hereby incorporated herein by reference.

### TECHNICAL FIELD

The present disclosure relates to a terminal, a server, a multi mobility service system including the same, and a method thereof.

### BACKGROUND

Recently, a field of a mobility service that facilitates traveling of a user is growing to solve problems such as air pollution, lack of parking space, and the like as well as traffic congestion due to vehicles concentrated in a city. The mobility service is a service developed to enable the users to use means of transportation conveniently, easily, and inexpensively based on information and communication technologies. In general, the mobility service is concentrated only on the traveling of the individual user, so that the mobility service is difficult to be applied when a plurality of users travel. Moreover, a multi-mobility service, including vehicles, public transportation, and an entire sharing economy, is underdeveloped. Therefore, it is difficult to provide paths through which the plurality of users may travel at an optimal cost and time in a multi mobility providing environment.

### SUMMARY

An aspect of the present disclosure provides a terminal, a server, a multi mobility service system including the same, and a method thereof that provide a path for traveling with optimal cost and time for a plurality of users.

Embodiments of the present inventive concept are not limited to the aforementioned problems, and any other technical problems not mentioned herein will be clearly understood from the following description by those skilled in the art to which the present disclosure pertains.

According to an aspect of the present disclosure, a multi mobility service system includes a plurality of terminals for generating user preferences based on vehicle information and user information, and a server for generating traveling path information for passing through a selected gathering place among one or more gathering places derived based on the user preferences.

In one embodiment, the user information may include initial user information and current user information.

In one embodiment, each of the plurality of terminals may set prior weights for one or more preferred items based on the initial user information, set additional weights for the preferred items based on the current user information, and generate the user preferences based on the prior weights and the additional weights.

In one embodiment, the server may generate the one or more gathering places based on locations of the plurality of terminals, calculates scores for the one or more gathering place based on the user preferences, and derive one or more suggested gathering places to be transmitted to the plurality of terminals based on the calculated scores.

In one embodiment, one of the plurality of terminals may select one of the one or more suggested gathering places received from the server, and transmit the selected suggested gathering place to the server.

In one embodiment, the server may generate a plurality of suggested gathering place information included in the selected suggested gathering place, calculate scores based on user weights for the plurality of suggested gathering place information, and derive one or more suggested gathering place information to be transmitted to the plurality of terminals based on the calculated scores.

In one embodiment, one of the plurality of terminals may select one of the one or more suggested gathering place information received from the server, and transmit the selected suggested gathering place information to the server.

In one embodiment, the server may generate traveling path information for traveling from the selected suggested gathering place to a destination based on the selected suggested gathering place information.

In one embodiment, the traveling path information may include vehicle reservation information and cost information.

In one embodiment, the server may perform a payment of the cost through a content provider.

According to another aspect of the present disclosure, a terminal includes an input device for receiving user information, and a controller that generates user preferences based on the user information and vehicle information, and when one of one or more gathering places derived based on the user preferences from a server is selected by a user, transmits the selected gathering place to the server.

According to another aspect of the present disclosure, a server includes a communicator that receives user preferences generated from a terminal based on user information and vehicle information, and a controller that generates traveling path information for passing through a selected gathering place among one or more gathering places derived based on the user preferences.

According to another aspect of the present disclosure, a method of a multi mobility service includes generating user preferences based on vehicle information and user information, and generating traveling path information for passing through a selected gathering place among one or more gathering places derived based on the user preferences.

In one embodiment, the user information may include initial user information and current user information.

In one embodiment, the generating of the user preferences may include setting prior weights for one or more preferred items based on the initial user information, setting additional weights for the preferred items based on the current user information, and generating the user preferences based on the prior weights and the additional weights.

In one embodiment, the method may further include, after the generating of the user preferences, generating one or more gathering places based on locations of a plurality of terminals, calculating scores for the one or more gathering place based on the user preferences, and deriving one or more suggested gathering places to be transmitted to the plurality of terminals based on the calculated scores.

In one embodiment, the method may further include, after deriving of the one or more suggested gathering places, selecting one of the one or more suggested gathering places received from a server, and transmitting the selected suggested gathering place to the server.

In one embodiment, the method may further include, after the transmitting of the selected suggested gathering place to the server, generating a plurality of suggested gathering place information about the selected suggested gathering place, calculating scores based on user weights for the plurality of suggested gathering place information, and deriving one or more suggested gathering place information to be transmitted to the plurality of terminals based on the calculated scores.

In one embodiment, the method may further include, after the deriving of the one or more suggested gathering place information, selecting, by one of the plurality of terminals, one of the one or more suggested gathering place information received from the server, and transmitting the selected suggested gathering place information to the server.

In one embodiment, the generating of the traveling path information may include generating traveling path information for traveling from the selected suggested gathering place to a destination based on the selected suggested gathering place information.

In one embodiment, the traveling path information may include vehicle reservation information and cost information.

In one embodiment, the method may further include, after the generating of the traveling path information, performing a payment of the cost through a content provider.

### BRIEF DESCRIPTION OF THE DRAWINGS

The above and other features and advantages of the present disclosure will be more apparent from the following detailed description taken in conjunction with the accompanying drawings:

FIG. 1 is a diagram illustrating a configuration of a multi mobility service system according to one embodiment of the present disclosure;

FIG. 2 is a diagram illustrating a configuration of a terminal according to one embodiment of the present disclosure;

FIG. 3 is a diagram illustrating a configuration of a server according to one embodiment of the present disclosure;

FIG. 4 is a diagram illustrating elements considered in generating a traveling path according to one embodiment of the present disclosure;

FIG. 5 is a view schematically illustrating paths generated according to one embodiment of the present disclosure; and

FIG. 6 is a flowchart illustrating a method of a multi mobility service according to one embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

FIG. 1 is a diagram illustrating a configuration of a multi mobility service system according to one embodiment of the present disclosure.

As shown in FIG. 1, a multi mobility service system 100 according to an embodiment of the present disclosure may include a terminal 110 and a server 120.

The terminal 110 may include a smart phone, a laptop, and the like, which may be carried by a user, and may include a vehicle terminal provided in a vehicle. When the terminal 110 is the vehicle terminal provided in the vehicle, vehicle information may be received from a sensor disposed in the vehicle. However, when the terminal 110 is the smart phone or the laptop that may be carried by the user, the terminal 110 may be wirelessly in communication with the vehicle and receive the vehicle information from the vehicle.

The multi mobility service system 100 according to an embodiment of the present disclosure may include the plurality of terminals 110. The terminal 110 may generate a user preference based on the vehicle information and user information. A more detailed description will be achieved with reference to FIG. 2.

The server 120 may receive location information from the terminal 110 to derive a plurality of gathering places, and provide traveling path information for passing through a selected gathering place among the plurality of gathering places. A more detailed description will be achieved with reference to FIG. 3.

FIG. 2 is a diagram illustrating a configuration of a terminal according to one embodiment of the present disclosure.

As shown in FIG. 2, the terminal 110 according to an embodiment of the present disclosure may include a communicator 111, a sensor 112, an input device 113, an output device 114, and a controller 115.

The communicator 111 may communicate with the server 120 to transmit the vehicle information and the user information to the server 120. The communicator 111 may communicate wirelessly, and may communicate with the server 120 in various wireless communication schemes such as a Wi-Fi, a WiBro, a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), a Long Term Evolution (LTE), and the like, as an example. When the terminal 110 is not provided in the vehicle and provided in a form portable by the user, the communicator 111 may receive vehicle information in association with the vehicle. In various embodiments, the communicator 111 may comprise a transmitter with a transmitter circuit to transmit the vehicle information and the user information to the server 120 and/or a receiver with a receiver circuit to receive vehicle information in association with the vehicle.

The sensor 112 may obtain the vehicle information, and the vehicle information may include a location of the vehicle, a speed of the vehicle, weather, a state of a road surface, the number of passengers, and the like. To this end, the sensor 112 may include a vehicle speed sensor, a weather sensor, an image sensor, a seat sensor, and the like.

The input device 113 may receive the user information. In this connection, the user information may include initial user information and current user information. The initial user information may refer to user information that is input primarily, and for example, may include age, gender, a place of residence, payment information (credit card information), a preferred item, and the like of the user. In this connection, the preferred item may include cost minimization, time minimization, fatigue degree minimization, and the like, and the input device 113 may receive at least one of those as the preferred item. In addition, the current user information may include information at a current time point for traveling to a destination, for example, a traveling history (navigation usage information) up to the current time point, information about the number of passengers currently in the vehicle, a preferred item at the current time point, and the like. In this connection, the preferred item may include cost minimization, time minimization, fatigue degree minimization, and the like, and the input device 113 may receive at least one of those as the preferred item at the current time point. In this connection, the preferred item at the current time point may vary based on a state of the user at the current time point. In addition, the input device 113 may receive an input signal corresponding to manipulation, operation, or voice of the user from the server 120, and select one of the information received.

The output device 114 may output the information received from the server 120. To this end, the output device 114 may be implemented as a display device or a sound output device.

The controller 115 may be implemented by various processing devices, such as a microprocessor with a built-in semiconductor chip capable of performing calculation or execution of various commands by executing a program stored in a non-volatile memory. The controller 115 may control overall operations of the terminal according to an embodiment of the present disclosure by executing the program stored in the non-volatile memory. Specifically, the controller 115 may generate the user preference based on the vehicle information and the user information, and output the information received from the server 120 through the output device 114. The controller 115 may obtain the vehicle information from the sensor 112 when the terminal 110 is provided in the vehicle, and may obtain the vehicle information in association with the vehicle when the terminal 110 is not provided in the vehicle.

More specifically, the controller 115 may set prior weights for one or more preferred items based on the initial user information, set additional weights for the preferred items based on the current user information, and generate the user preference based on the prior weights and the additional weights. According to an embodiment, the user preference may be set as shown in Table 1. In this connection, the prior weights may be set such that a sum of ratios of the preferred items is 1, and the additional weights may be set such that a sum of ratios of the preferred items is a user set value. For example, the user set value may include 0.3, 0.5, and 0.8.

TABLE 1

| Starting point | | Additional | |
|---|---|---|---|
| (terminal location) | Prior weight | weight | User preference |
| A | Cost 0.3 | Time 0.5 | Cost 1.2 |
| | Time 0.6 | | Time 1.3 |
| | Fatigue | | Fatigue |
| | degree 0.1 | | degree 0.5 --> |
| B | Cost 0.2 | Not selected | Cost 1.2 |
| | Time 0.5 | | Time 1.8 |
| | Fatigue | | Fatigue |
| | degree 0.3 | | degree 1.0 |
| C | Cost 0.7 | Fatigue | |
| | Time 0.5 | degree 0.5 | |
| | Fatigue | | |
| | degree 0.1 | | |
| D | Meaningless | Not selected | |
| | because | | |
| | weight is 1 | | |

In a detailed description of Table 1, in a case of a terminal C, although the controller 115 set a maximum weight for the cost minimization based on the preferred item primarily input by the user, when there is a passenger at the current time point and when the user inputs the fatigue degree minimization to minimize the fatigue degree, the controller 115 may further assign the additional weight to the fatigue degree minimization.

In addition, when selecting one of the information received from the server 120, the controller 115 may control to transmit the selected information to the server 120. As an example, the controller 115 may receive one or more gathering places derived from the server 120, and when it is determined that the user selected one gathering place, the controller 115 may control to transmit the gathering place selected by the user to the server 120. In addition, the controller 115 may receive one or more suggested gathering place information generated from the server 120, and when it is determined that the user selected one of the suggested gathering place information, the controller 115 may control to transmit the suggested gathering place information selected by the user to the server 120.

FIG. 3 is a diagram illustrating a configuration of a server according to one embodiment of the present disclosure.

As shown in FIG. 3, the server 120 according to an embodiment of the present disclosure may include a communicator 121, storage 122, and a controller 123.

The communicator 121 may communicate with the terminal 110 to transmit the information generated by the controller 123 to the terminal 110. The communicator 121 may communicate wirelessly, and may communicate with the terminal 110 in various wireless communication scheme such as a Wi-Fi, a WiBro, a Global System for Mobile communication (GSM), a Code Division Multiple Access (CDMA), a Wideband Code Division Multiple Access (WCDMA), a Universal Mobile Telecommunication System (UMTS), a Time Division Multiple Access (TDMA), a Long Term Evolution (LTE), and the like, as an example. In various embodiments, the communicator 121 may comprise a transmitter with a transmitter circuit to transmit the information generated by the controller 123 to the terminal 110.

The storage 122 may store the user preference received from the terminal 110. In addition, the storage 122 may store a program comprising at least one algorithm that performs calculation or execution of various commands for an operation of the server according to an embodiment of the present disclosure. The storage 122 may include at least one storage medium of a flash memory, a hard disk, a memory card, a read-only memory (ROM), a random access memory (RAM), an electrically erasable programmable read-only memory (EEPROM), a programmable read-only memory (PROM), a magnetic memory, a magnetic disk, and an optical disk.

The controller 123 may be implemented by various processing devices, such as a microprocessor with a built-in semiconductor chip capable of performing calculation or execution of various commands by, e..g, executing the program stored in the storage 122. The controller 123 may control overall operations of the terminal according to an embodiment of the present disclosure by executing, e.g., the program stored in the storage 122. Specifically, the controller 123 may provide the traveling path information for passing through the selected gathering place among the one or more gathering places derived based on the user preference.

More specifically, the controller 123 may generate a candidate group of one or more gathering places based on a plurality of terminal locations. According to an embodiment, the controller 123 may generate the gathering place candidate group at an intermediate point between the plurality of terminal locations and a destination location, and the gathering place candidate group may include a place capable of providing means of transportation to the destination. For example, the gathering place candidate group may include a car sharing company, a car rental company, a public parking lot, a home parking lot, and the like.

In addition, the controller 123 may receive user preferences of terminal users from the plurality of terminals, respectively. In addition, the controller 123 may receive external environment information. In this connection, the external environment information may include road guidance information received from a road guidance server, traffic information (public transportation, accident, and traffic volume information) received from an information providing content provider, and weather information.

The controller 123 may calculate scores for the one or more gathering places based on times, costs, and fatigue degrees required to pass through the one or more gathering places from the plurality of terminals to the destination. According to an embodiment of the present disclosure, when the controller 123 generates one or more gathering places as E1, E2, E3, and E4 for traveling from terminal locations A, B, C, and D to a destination G, a cost score for E1 may be calculated by a following Calculation Formula 1. In Calculation Formula 1, the cost score is calculated based on a product of a cost required to travel and a user preference associated with the cost, but the present disclosure is not limited thereto, and the cost score may be calculated based on the external environment information.

E1 cost score=K1{(Cost spent for traveling from location A to E1*User preference associated with cost)+(Cost spent for traveling from location B to E1*User preference associated with cost)+(Cost spent for traveling from location C to E1*User preference associated with cost)+(Cost spent for traveling from location D to E1*User preference associated with cost)}+K2(Cost spent for traveling from location E1 to G*User preference associated with cost) Calculation Formula 1

In this connection, K1 and K2 are coefficients (change based on the number of passengers or the number of vehicles).

The controller 123 may calculate a cost score, a time score, and a fatigue degree score for each of the one or more gathering places E1, E2, E3, and E4 using the calculation scheme of Calculation Formula 1, and may derive one or more suggested gathering places to be suggested to the user based on the calculated scores. According to an embodiment, when it is determined that it is most suitable to travel by passing through the gathering place E2 or E4 as a path advantageous in terms of the time and the cost based on the calculated scores, the controller 123 may control to transmit E2 and E4 as the suggested gathering places to the plurality of terminals.

When receiving user feedback information of selecting one of the suggested gathering places from at least one of the plurality of terminals, the controller 123 derives the suggested gathering place information based on the user preference and the external environment information. According to an embodiment, when the suggested gathering place is determined to be E2, the controller 123 may generate a suggested gathering place candidate group. In this connection, the suggested gathering place candidate group may include different car sharing companies near the suggested gathering place. For example, the suggested gathering place candidate group may include car sharing companies E2-1, E2-2, and E2-3.

The controller 123 may calculate scores for one or more suggested gathering places based on time, cost, and fatigue degree required to travel from the plurality of terminals to the destination by passing through one or more suggested gathering places among the suggested gathering place candidate group. According to an embodiment of the present disclosure, when the one or more suggested gathering places among the suggested gathering place candidate group are passed through to travel from the terminal locations A, B, C, and D to the destination G, the controller 123 may calculate a cost score, a time score, and a fatigue degree score for each of the one or more suggested gathering places of E2-1, E2-2, and E2-3. In this connection, the cost score, the time score, and the fatigue degree score may be calculated in the same calculation method as Calculation Formula 1 by changing E1 of Calculation Formula 1 to E2-1, E2-2, and E2-3. The controller 123 may derive one or more suggested gathering place information to be suggested to the user based on the calculated scores, and may control to transmit the suggested gathering place information to the terminal 110.

The controller 123 receives a result (final selection information) of selection of one of the suggested gathering place information from at least one terminal among the plurality of terminals, and when the final selection information is E2-1, the controller 123 generates traveling path information between the selected suggested gathering place E2-1 and the destination. In this connection, the traveling path information may include round trip traveling path between the suggested gathering place E2-1 and the destination and cost information for traveling from the suggested gathering place E2-1 to the destination. In addition, when generating the traveling path information, the controller 123 may perform payment for the cost in association with the service providing content provider, or may return to the suggested gathering place E2-1 and allow the vehicle to be parked.

FIG. 4 is a diagram illustrating elements considered in generating a traveling path according to one embodiment of the present disclosure.

The multi mobility service system according to an embodiment of the present disclosure may propose an optimal gathering place to users at different locations based on elements included in FIG. 4, and provide a scheme for traveling to the destination in consideration of the user preference.

FIG. 5 is a view schematically illustrating paths generated according to one embodiment of the present disclosure.

As shown in FIG. 5, the server 120 may generate the one or more gathering places for traveling from the plurality of terminal locations A, B, C, and D to the destination G. In this connection, the one or more gathering places may be generated as the intermediate points from the terminal locations (i.e., the starting points A, B, C, and D) to the destination G, and may include a place that may provide means of transportation to the destination. According to an embodiment of the present disclosure, the server 120 may generate E1 (public parking lot), E2 (car sharing parking lot), E3 (car rental office), and E4 (C home parking lot) as the one or more gathering places.

FIG. 6 is a flowchart illustrating a method of a multi mobility service according to one embodiment of the present disclosure.

As shown in FIG. 6, the terminal 110 obtains the initial user information (S110). In S110, the initial user information may refer to the user information that is input primarily, and for example, may include the age, the gender, the place of residence, the payment information (credit card information), the preferred item, and the like of the user. In this connection, the preferred item may include the cost minimization, the time minimization, the fatigue degree minimization, and the like, and at least one of those may be received as the preferred item.

The terminal 110 may obtain the current user information (S120). In S120, the current user information may mean the user information at the current time point for traveling to the destination, and for example, may include the traveling history (navigation usage information) up to the current time point, the information about the number of passengers currently in the vehicle, the preferred item at the current time point, and the like.

The terminal 110 may generate the user preference (S130). In S130, the terminal 110 may set the prior weights for the one or more preferred items based on the initial user information, set the additional weights for the preferred items based on the current user information, and generate the user preference based on the prior weights and the additional weights. According to an embodiment, the user preference may be set as shown in Table 1.

When the user preference is generated, the terminal 110 transmits the user preference to the server 120 (S140). The server 120 may receive the user preference from the terminal (S150), and aggregate the external environment information (S160). In S160, the external environment information may include the road guidance information received from the road guidance server, the traffic information (public transportation, accident, and traffic volume information) received from the information providing content provider, and the weather information.

The server 120 may generate the candidate group of the one or more gathering places based on the plurality of terminal locations, and may calculate the scores for each gathering place (S170). In S170, first, the server 120 may generate the gathering place candidate group at the intermediate point between the plurality of terminal locations and the destination location, and the gathering place candidate group may include the place capable of providing the means of transportation to the destination. For example, the gathering place candidate group may include the car sharing company, the car rental company, the public parking lot, the home parking lot, and the like.

In addition, in S110, the server 120 may calculate the scores for the one or more gathering places based on the times, the costs, and the fatigue degrees required to pass through the one or more gathering places from the plurality of terminals to the destination. According to an embodiment of the present disclosure, when the server 120 generates the one or more gathering places as E1, E2, E3, and E4 for the traveling from the terminal locations A, B, C, and D to the destination G, the cost score for E1 may be calculated by the above Calculation Formula 1. The server 120 may calculate the cost score, the time score, and the fatigue degree score for each of the one or more gathering places E1, E2, E3, and E4 using the calculation scheme of Calculation Formula 1.

The server 120 may derive the one or more suggested gathering places to be suggested to the user based on the scores calculated for each gathering place (S180). According to an embodiment, when it is determined in S180 that it is most suitable to travel by passing through the gathering place E2 or E4 as the path advantageous in terms of the time and the cost based on the calculated scores, the server 120 may control to transmit E2 and E4 as the suggested gathering places to the plurality of terminals (S190).

The terminal 110 may select one of the suggested gathering places received from the server 120 and generate the user feedback information (S200). When the user feedback information is generated to indicate the E2 is selected as the suggested gathering place in S200, the terminal 110 may transmit the user feedback information to the server 120 (S210).

When receiving the user feedback information, the server 120 calculates the scores for each suggested gathering place based on the user feedback information (S220). According to an embodiment, when it is determined in S220 that the suggested gathering place is E2, the server 120 may generate the suggested gathering place candidate group. In this connection, the suggested gathering place candidate group may include the different car sharing companies near the suggested gathering place. For example, the suggested gathering place candidate group may include the car sharing companies E2-1, E2-2, and E2-3.

In S220, the server 120 may calculate the scores for the one or more suggested gathering places based on the time, the cost, and the fatigue degree required to travel from the plurality of terminals to the destination by passing through the one or more suggested gathering places among the suggested gathering place candidate group. According to an embodiment of the present disclosure, when the one or more suggested gathering places among the suggested gathering place candidate group are passed through to travel from the terminal locations A, B, C, and D to the destination G, the time score, and the fatigue degree score for each of the one or more suggested gathering places among the suggested gathering place candidate group of E2-1, E2-2, and E2-3 may be calculated. In this connection, the cost score, the time score, and the fatigue degree score may be calculated in the same calculation method as Calculation Formula 1 by changing E1 of Calculation Formula 1 to E2-1, E2-2, and E2-3.

The server 120 may derive the suggested gathering place information based on the scores calculated in S220 (S230), and may control to transmit the suggested gathering place information to the terminal 110 (S240).

In addition, the terminal 110 receives the one or more gathering place information generated from the server 120, and when it is determined that the user selected one of the gathering place information, generates the final selection information (S250), and then transmits the final selection information to the server 120 (S260).

When the final selection information received from the terminal 110 is E2-1, the server 120 generates the traveling path information between the selected suggested gathering place E2-1 and the destination (S270). In S270, the traveling path information may include the round trip traveling path between the suggested gathering place E2-1 and the destination and the cost information for traveling from the suggested gathering place E2-1 to the destination. In addition, the server 120 may perform the payment for the cost in association with the service providing content provider, or may return to the suggested gathering place E2-1 and allow the vehicle to be parked.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

According to an embodiment of the present disclosure, the terminal, the server, the multi mobility service system including the same, and the method thereof may provide a service that provides a path for traveling to a destination with optimal cost and time by reflecting preferences of a plurality of users, and automatically pays a cost generated when traveling. In addition, the present disclosure may also protect the environment through a carpool system, revitalization of public transportation, and exhaust reduction.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A multi mobility service system comprising:
a plurality of terminals for generating user preferences based on vehicle information and user information; and
a server for generating traveling path information for passing through a selected gathering place from one or more gathering places derived based on the user preferences.

2. The multi mobility service system of claim 1, wherein the user information includes initial user information and current user information.

3. The multi mobility service system of claim 2, wherein each of the plurality of terminals sets prior weights for one or more preferred items based on the initial user information, sets additional weights for the preferred items based on the current user information, and generates the user preferences based on the prior weights and the additional weights.

4. The multi mobility service system of claim 1, wherein the server generates the one or more gathering places based on locations of the plurality of terminals, calculates scores for the one or more gathering places based on the user preferences, and derives one or more suggested gathering places to be transmitted to the plurality of terminals based on the calculated scores.

5. The multi mobility service system of claim 4, wherein one of the plurality of terminals selects one of the one or more suggested gathering places received from the server, and transmits a selected suggested gathering place to the server.

6. The multi mobility service system of claim 5, wherein the server generates a plurality of suggested gathering place information included in the selected suggested gathering place, calculates scores based on user weights for the plurality of suggested gathering place information, and derives one or more suggested gathering place information to be transmitted to the plurality of terminals based on the calculated scores.

7. The multi mobility service system of claim 6, wherein one of the plurality of terminals selects one of the one or more suggested gathering place information received from the server, and transmits a selected suggested gathering place information to the server.

8. The multi mobility service system of claim 6, wherein the server generates traveling path information for traveling from a selected suggested gathering place to a destination based on the selected suggested gathering place information.

9. The multi mobility service system of claim 1, wherein the traveling path information includes vehicle reservation information and cost information.

10. The multi mobility service system of claim 9, wherein the server performs a payment of the cost through a content provider.

11. A terminal comprising:
an input device for receiving user information;
a controller configured to execute a program;
a non-volatile memory storing the program, the program when executed causes the controller to:
generate user preferences based on the user information and vehicle information; and
a transmitter configured to transmit a selected gathering place to a server when one of one or more gathering places derived based on the user preferences from the server is selected.

12. A server comprising:
a receiving circuit configured to receive user preferences generated from a terminal based on user information and vehicle information; and
a controller configured to execute a program; and
a non-volatile memory storing the program, the program when executed causes the controller to generate traveling path information for passing through a selected gathering place from one or more gathering places derived based on the user preferences.

13. A method of a multi mobility service, the method comprising:
generating user preferences based on vehicle information and user information; and
generating traveling path information for passing through a selected gathering place among one or more gathering places derived based on the user preferences.

14. The method of claim 13, wherein the user information includes initial user information and current user information.

15. The method of claim 14, wherein the generating of the user preferences includes:
setting prior weights for one or more preferred items based on the initial user information;
setting additional weights for the preferred items based on the current user information; and
generating the user preferences based on the prior weights and the additional weights.

16. The method of claim 13, further comprising:
after the generating of the user preferences,
generating one or more gathering places based on locations of a plurality of terminals;
calculating scores for the one or more gathering place based on the user preferences; and
deriving one or more suggested gathering places to be transmitted to a plurality of terminals based on the calculated scores.

17. The method of claim i6, further comprising:
after deriving of the one or more suggested gathering places,
selecting one of the one or more suggested gathering places received from a server; and
transmitting the selected suggested gathering place to the server.

18. The method of claim 17, further comprising:
after the transmitting of the selected suggested gathering place to the server,
generating a plurality of suggested gathering place information about the selected suggested gathering place;
calculating scores based on user weights for the plurality of suggested gathering place information; and
deriving one or more suggested gathering place information to be transmitted to a plurality of terminals based on the calculated scores.

19. The method of claim 18, further comprising:
after the deriving of the one or more suggested gathering place information,
selecting, by one of the plurality of terminals, one of the one or more suggested gathering place information received from the server; and
transmitting the selected suggested gathering place information to the server.

20. The method of claim 18, wherein the generating of the traveling path information includes:
generating traveling path information for traveling from the selected suggested gathering place to a destination based on the selected suggested gathering place information.

21. The method of claim 13, wherein the traveling path information includes vehicle reservation information and cost information.

22. The method of claim 21, further comprising:
after the generating of the traveling path information,
performing a payment of the cost through a content provider.
